(19) United States
(12) Patent Application Publication
(10) Pub. No.: US 2003/0036807 A1
(43) Pub. Date: Feb. 20, 2003

(54) Multiple master digital addressable lighting interface (DALI) system, method and apparatus

(76) Inventor: Ross M. Fosler, Chandler, AZ (US)

Correspondence Address: BAKER BOTTS, LLP, 910 LOUISIANA, HOUSTON, TX, 77002-4995, US

(21) Appl. No.: 09/929,632

(22) Filed: Aug. 14, 2001

(51) Int. Cl. G05B 19/18; G06F 13/00; G06F 15/16

(52) U.S. Cl. 700/3; 710/110; 709/208; 709/211; 700/2

(57) ABSTRACT

A Digital Addressable Lighting Interface (DALI) master and DALI control bus power supply in combination with at least one DALI sub-master are connected to a single DALI control bus. The single DALI control bus may have a plurality of DALI slave devices, e.g., luminaries connected thereto and disbursed throughout a plurality of offices and/or rooms. The DALI master and the at least one DALI sub-master allow local control of the lighting in each office or room while maintaining the simplicity and cost effectiveness of a single DALI control bus system. Collision of commands sent simultaneously by two or more DALI masters may be detected and the corrupted commands retransmitted.

### FIELD OF THE INVENTION

The present invention relates generally to control and status of building lighting and power systems, and more particularly to a digital addressable lighting interface (DALI) system having multiple masters.

### BACKGROUND OF THE INVENTION TECHNOLOGY

The demands imposed on lighting systems have changed considerably in recent years. Heretofore, switching individual or groups of luminaries on and off used to be sufficient, however, the focus for today and in the future will be on dynamic lighting. Energy conservation, more flexibility of use, increased life and reduced maintenance costs of lighting systems require lighting scene control. To create lighting scenes, luminaries generally are assigned to a plurality of groups. In addition, an end user preferably wants the option of controlling his or her luminaries. If installations having this type of flexibility are integrated into a building management system, there is also a need for simple check-back of operational status as well as global on/off control.

One method of implementing flexibility in the control of luminaries has been achieved using a new industrial standard for addressable digital lighting control called “Digital Addressable Lighting Interface” or “DALI.” The DALI standard specifies how to control and monitor the status of individual and group addressable lighting equipment such as electronic ballasts and illumination sensors The DALI standard uses a two wire low voltage control circuit for addressing, controlling and monitoring the status of connected DALI compliant devices (DALI slaves). The DALI standard also specifies how to determine the status of the amount of light of addressed luminaries as well as information from fire and security sensors.

DALI compliant electronic ballasts are now being manufactured which comprise all circuitry necessary to control the power to and lighting levels of a connected fluorescent lamp(s). The only connections required to these DALI compliant ballasts are power and a low voltage two wire DALI control circuit. Each DALI compliant ballast also has a unique address as well as being assignable to a group address. Up to 64 DALI devices may be controlled on a single DALI control bus with a single DALI master. The control and address capabilities of a DALI compliant lighting system allow individual control of the light level of each the luminaries as well as easily controlling light levels for groups of luminaries.

The DALI messages are serial data streams and comply with a bi-phase, or Manchester, coding in which the bit values “1” and “0” are presented as two different voltage levels, e.g., 16 volts and 0 volts, respectively. The coding includes error detection. A power source is provided with a DALI master to generate the required voltage level and the DALI master generates the DALI messages used to control the DALI slaves (e.g., lighting ballasts). The DALI interfaces are connected to a two wire DALI control bus which is common to all or groups of the DALI interfaces (up to 64 DALI interfaces per DALI control bus). Each DALI interface receives information by determining the voltage changes representing the bit values, and transmits information by either not clamping a voltage or clamping (shorting) the voltage across the two wire DALI control bus.

DALI messages consist of an address part and a command part (hereinafter “DALI protocol”). The address part determines for which DALI device the message is intended. All DALI devices may execute commands with broadcast addresses. Sixty-four unique addresses are available plus sixteen group addresses. A particular DALI device may belong to more than one group. The light level is defined in DALI messages using an 8-bit number. The value “0” (zero) means that the lamp is not lit. The DALI standard determines the light levels so that they comply with the logarithmic curve in which the human eye observes the light level change in a linear fashion. All DALI compliant ballasts and DALI slave controllers adhere to the same logarithmic curve irrespective of their absolute minimum level. The DALI standard determines the light levels over a range of 0.1 percent to 100 percent, e.g., level 1 of the DALI standard corresponds to a light level of 0.1 percent. The DALI protocol and the DALI two wire hardware interface are unique for controlling and monitoring power devices such as lighting.

Controlling luminaries, e.g., fluorescent lights, in large open office areas using the DALI protocol with a single control bus and DALI master works well, however, when smaller areas, e.g., rooms, offices, conference rooms, lunch room, store room, closet, hall, coffee bar, bathroom, laboratory, reception area, lobby, etc., require specific control of the lighting therein, a central common master DALI master is not always practical. A separate DALI control bus, DALI master and bus power supply may be used for each area, however, increased wiring costs, e.g., additional control buses, and component costs, e.g., bus power supplies must be used. Therefore, as DALI compliant devices in lighting systems become more prevalent, what is needed is a simple, reliable and cost effective way to control these DALI compliant devices located in smaller or specific areas such as offices and other types of rooms, e.g., conference room, lunch room, coffee bar, bathroom, reception area and the like.

### SUMMARY OF THE INVENTION

The invention overcomes the above-identified problems as well as other shortcomings and deficiencies of existing technologies by providing a system, method and apparatus for controlling DALI compliant devices (luminaries) in smaller localized areas while retaining maximum utilization of the capabilities of the DALI control bus (e.g., up to 64 DALI slaves). The present invention comprises a DALI master and DALI control bus power supply in combination with at least one DALI sub-master connected to a single DALI control bus. The single DALI control bus may have a plurality of DALI slave devices, e.g., luminaries connected thereto and disbursed throughout a plurality of offices and/or rooms. The present invention enables local control of the lighting in each office or room while maintaining the simplicity and cost effectiveness of a single DALI control bus system. In addition, the present invention enables multiple access points for controlling all of the DALI slaves connected to a single DALI control bus. When two or more DALI masters (i.e., master and/or one or more sub-masters) are activated at the same time, collision detection and retransmission of corrupted command signals from any of the multiple DALI masters is contemplated and within the scope of the present invention.

In accordance with an exemplary embodiment, the present invention is directed to a system for controlling luminaries from a plurality of different locations over a digital addressable lighting interface (DALI) control bus, said system comprising: a plurality of luminaries connected to a power source and a digital addressable lighting interface (DALI) control bus; a DALI master connected to said DALI control bus; a DALI control bus power supply connected to said DALI control bus; and at least one DALI sub-master connected to said DALI control bus, wherein said DALI master and said at least one DALI sub-master control different ones of said plurality of luminaries.

The present invention is also directed to a method of operation for controlling luminaries from a plurality of different locations over a digital addressable lighting interface (DALI) control bus, said method comprising the steps of: connecting a plurality of luminaries, a DALI master, a DALI control bus power supply and at least one DALI sub-master to a digital addressable lighting interface (DALI) control bus; controlling at least one of said plurality of luminaries with said DALI master; and controlling at least one other of said plurality of luminaries with said at least one DALI sub-master.

The present invention is also directed to an apparatus for controlling luminaries from a plurality of different locations over a digital addressable lighting interface (DALI) control bus, said system comprising: a DALI master having command transmission collision detection and command retransmssion; and a DALI sub-master having command transmission collision detection and command retransmssion, wherein said DALI master and said DALI sub-master are adapted for connection to a plurality of luminaries with a DALI control bus.

The luminaries may be for example, but not limited to, an incandescent light, a fluorescent light, a high pressure gas electric discharge light, a low pressure gas electric discharge light, light emitting diode light and electroluminescent light. The present invention may also be used with a light damper on a window exposed to sunlight, remotely controllable window shades and remotely controllable window curtains. The present invention may also be used with a smoke detector, a fire detector, a motion detector, a light sensor, a temperature sensor and a humidity sensor. The present invention may further be connected to a building automation computer system.

A technical advantage of the present invention is simplification of control wiring.

Another technical advantage is a cost savings in needing only one control bus power supply and control bus for a lighting control in a plurality of offices and/or rooms.

Another technical advantage is control of a DALI system from multiple access points.

A feature of the present invention is local control of DALI devices in multiple offices and/or rooms.

Another feature is a single control bus and power supply for lighting control in a plurality of offices and/or rooms.

Another feature is collision detection and retransmission of commands when a collision is detected.

Another feature is retransmission of commands when an a transmission error is detected.

An advantage of the present invention is simplified installation of control circuits.

Another advantage is a reduction in control bus power supplies needed for controlling DALI slave devices in a plurality of offices and/or rooms.

Features and advantages of the invention will be apparent from the following description of the embodiments, given for the purpose of disclosure and taken in conjunction with the accompanying drawings.

### BRIEF DESCRIPTION OF THE DRAWINGS

A more complete understanding of the present disclosure and advantages thereof may be acquired by referring to the following description taken in conjunction with the accompanying drawing, wherein:

FIG. 1 illustrates a schematic block diagram of a DALI compliant electrical system, according to an exemplary embodiment of the invention;

FIG. 2 illustrates an exemplary schematic circuit diagram of the DALI master of FIG. 1; and

FIG. 3 illustrates an exemplary schematic circuit diagram of the DALI sub-master of FIG. 1.

While the present invention is susceptible to various modifications and alternative forms, specific exemplary embodiments thereof have been shown by way of example in the drawing and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

The present invention is directed to a system, method and apparatus comprising a DALI master and at least one DALI sub-master. DALI compliant devices (luminaries) in smaller areas may be locally controlled while retaining maximum utilization of the capabilities of the DALI control bus (e.g., up to 64 DALI slaves). Exemplary embodiments of the present invention include a DALI master and DALI control bus power supply in combination with at least one DALI sub-master, all connected to a single DALI control bus. The single DALI control bus may have a plurality of DALI slave devices, e.g., luminaries connected thereto and disbursed throughout a plurality of offices and/or rooms. The present invention enables local control of the lighting in each office or room while maintaining the simplicity and cost effectiveness of a single DALI control bus system. In addition, the present invention enables multiple access points for controlling all of the DALI slaves connected to a single DALI control bus. When two or more DALI masters (i.e., master and/or one or more sub-masters) are activated at the same time, collision detection and retransmission of corrupted command signals from any of the multiple DALI masters is contemplated and within the scope of the present invention.

Referring now to the drawings, the details of exemplary embodiments of the present invention are schematically illustrated. Like elements in the drawings will be represented by like numbers, and similar elements will be represented by like numbers with a different lower case letter suffix.

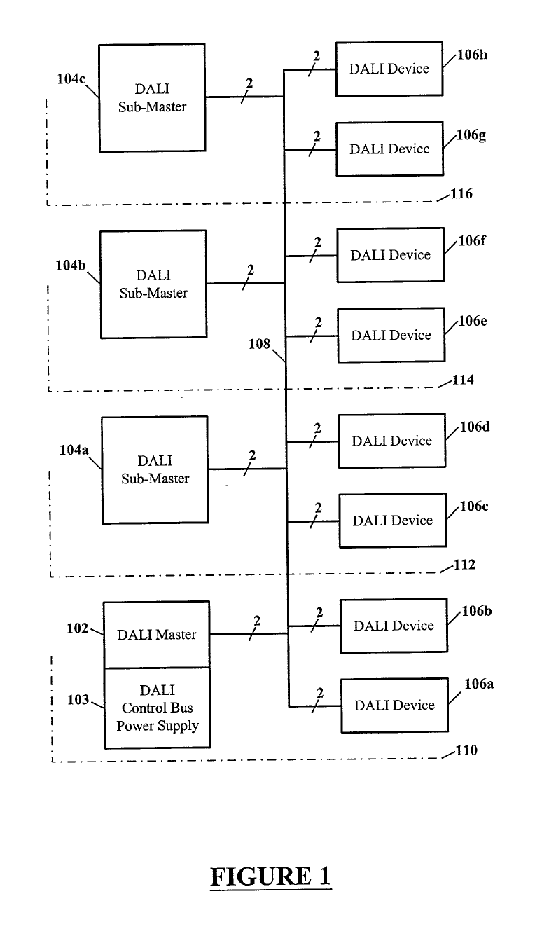

Referring to FIG. 1, depicted is a schematic block diagram of a DALI compliant electrical system, according to an exemplary embodiment of the invention. A DALI master 102 having a control bus power supply 103, a plurality of DALI sub-master 104, and a plurality of DALI compliant electrical devices 106 are connected to a single DALI control bus 108. The DALI master 102, control bus power supply 103 and DALI devices 106a and 106b are located in a room 110. The DALI sub-master 104a, and DALI devices 106c and 106d are located in another room 112. The DALI sub-master 104b, and DALI devices 106e and 106f are located in yet another room 114. The DALI sub-master 104c, and DALI devices 106g and 106h are located in yet another room 116. Any number of groupings of DALI sub-masters 104 and DALI devices 106 on a single DALI control bus 108 may be used so long as the maximum number of DALI devices does not exceed the maximum load (e.g., 64 devices) for that DALI bus 108. Using a DALI sub-master 104 for each area requiring local control does not affect group or remote control of the entire connected DALI devices 106. Collision detection and retransmission of corrupted command signals from the DALI master 102 or any of the DALI sub-masters 104 may also be incorporated into the present invention. The DALI master 102 or DALI sub-master 104 may monitor the transmission code being sent on the DALI bus 108. If the monitored DALI bus 108 transmission code is not the same as what is being sent, then a collision error is assumed and the command is resent. Other methods of collision detection may be implemented in the present invention and would be apparent to one having ordinary skill in the electronic arts and having the benefit of this disclosure.

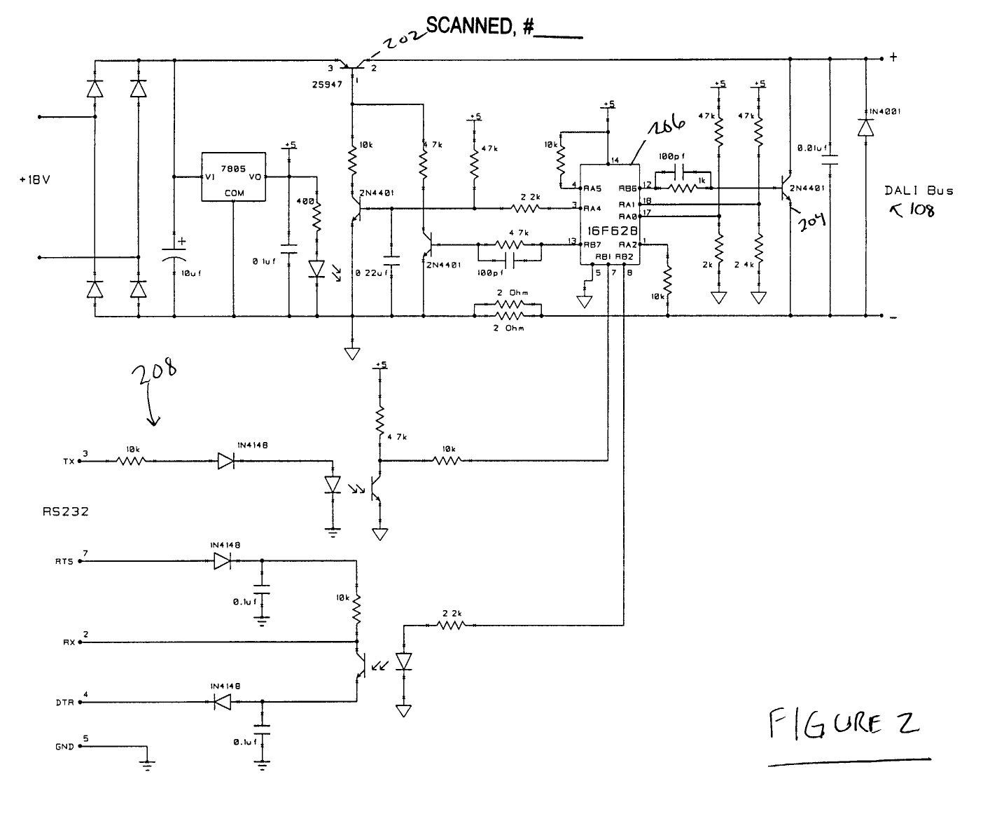

Referring to FIG. 2, depicted is an exemplary schematic circuit diagram of the DALI master 102 and DALI control bus power supply 103 illustrated in FIG. 1. A bridge rectifier is adapted to receive 18 volts AC or DC from a power source (not illustrated) and to convert the voltage from the power source into a DC voltage for the DALI control bus 108 and 5 volts DC for a microcontroller 206. Transistor 202 is a series pass transistor that limits current in the control bus 108 whenever the control bus 108 is shorted, e.g., command being sent by the master 102 or sub-master 104, or status being returned from one of the DALI devices 106. Transistor 204 is used to short the DALI control bus 108 for command signaling to the DALI devices 106. The microcontroller 206 may be used for logic control and command sequence formatting. An interface 208 may be coupled to the microcontroller 206 to provide an interface for a computer system (not illustrated). The interface 208 may be for example, but limited to, RS-232, RS-422, USB, etc. The DALI master 102 and DALI control bus power supply 103 may be at different locations or may be an integral assembly.

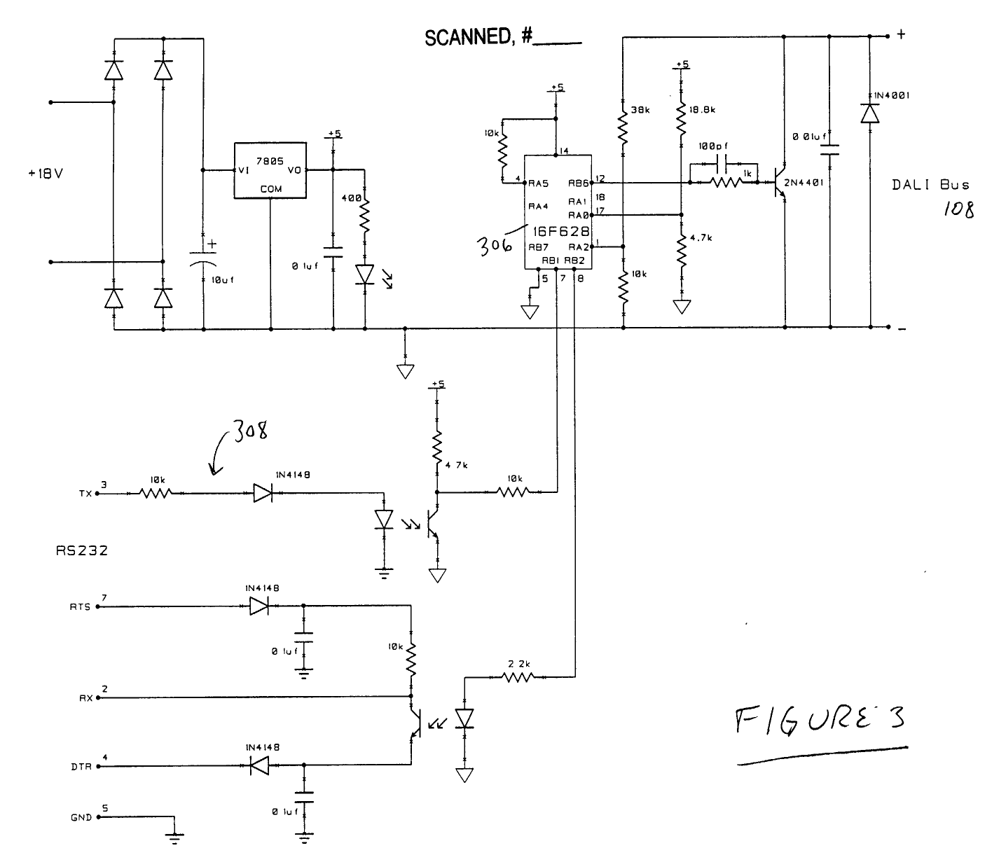

Referring to FIG. 3, depicted is an exemplary schematic circuit diagram of the DALI sub-master 104 illustrated in FIG. 1. A bridge rectifier is adapted to receive 18 volts AC or DC from a power source (not illustrated) and to convert the voltage from the power source into a DC voltage to power a microcontroller 306. Transistor 304 is used to short the DALI control bus 108 for command signaling to the DALI devices 106. The microcontroller 306 may be used for logic control and command sequence formatting. An RS-232 interface 308 may be coupled to the microcontroller 306 to provide an electrical interface for a computer system (not illustrated).

The invention, therefore, is well adapted to carry out the objects and attain the ends and advantages mentioned, as well as others inherent therein. While the invention has been depicted, described, and is defined by reference to exemplary embodiments of the invention, such references do not imply a limitation on the invention, and no such limitation is to be inferred. The invention is capable of considerable modification, alternation, and equivalents in form and function, as will occur to those ordinarily skilled in the pertinent arts and having the benefit of this disclosure. The depicted and described embodiments of the invention are exemplary only, and are not exhaustive of the scope of the invention. Consequently, the invention is intended to be limited only by the spirit and scope of the appended claims, giving full cognizance to equivalents in all respects.

What is claimed is:

1. A system for controlling luminaries from a plurality of different locations over a digital addressable lighting interface (DALI) control bus, said system comprising:
a plurality of luminaries connected to a power source and a digital addressable lighting interface (DALI) control bus;
a DALI master connected to said DALI control bus;
a DALI control bus power supply connected to said DALI control bus; and
at least one DALI sub-master connected to said DALI control bus, wherein said DALI master and said at least one DALI sub-master control different ones of said plurality of luminaries.

2. The system of claim 1, wherein said DALI master and said DALI sub-master are in different locations.

3. The system of claim 2, wherein the different locations are selected from the group consisting of room, office, conference room, lunch room, coffee bar, bathroom, laboratory, reception area, closet, storage room, hall and lobby.

4. The system of claim 1, wherein the ones of said plurality of luminaries controlled by said DALI master and the ones of said plurality of luminaries controlled by said DALI sub-master are in different locations.

5. The system of claim 4, wherein the different locations are selected from the group consisting of room, office, conference room, lunch room, coffee bar, bathroom, laboratory, reception area, closet, storage room, hall and lobby.

6. The system of claim 1, further comprising a computer interface coupled to said DALI master.

7. The system of claim 8, wherein said computer interface is selected from the group consisting of RS-232, RS-422 and USB.

8. The system of claim 1, further comprising a computer interface coupled to said at least one DALI sub-master.

9. The system of claim 8, wherein said computer interface is selected from the group consisting of RS-232, RS-422 and USB.

10. A method for controlling luminaries from a plurality of different locations over a digital addressable lighting interface (DALI) control bus, said method comprising the steps of:
connecting a plurality of luminaries, a DALI master, a DALI control bus power supply and at least one DALI sub-master to a digital addressable lighting interface (DALI) control bus;
controlling at least one of said plurality of luminaries with said DALI master; and
controlling at least one other of said plurality of luminaries with said at least one DALI sub-master.

11. The method of claim 10, wherein said DALI master and said DALI sub-master are in different locations.

12. The method of claim 11, wherein the different locations are selected from the group consisting of room, office, conference room, lunch room, coffee bar, bathroom, laboratory, reception area, closet, storage room, hall and lobby.

13. The method of claim 10, wherein the at least one of said plurality of luminaries controlled by said DALI master and the at least one other of said plurality of luminaries controlled by said DALI sub-master are in different locations.

14. The method of claim 13, wherein the different locations are selected from the group consisting of room, office, conference room, lunch room, coffee bar, bathroom, laboratory, reception area, closet, storage room, hall and lobby.

15. The method of claim 10, further comprising the step of coupling said DALI master to a computer.

16. The method of claim 15, wherein the step of coupling said DALI master to a computer is done with a serial communications interface.

17. The method of claim 16, wherein said serial communications interface is selected from the group consisting of RS-232, RS-422 and USB.

18. The method of claim 10, further comprising the step of coupling said DALI sub-master to a computer.

19. The method of claim 18, wherein the step of coupling said DALI sub-master to a computer is done with a serial communications interface.

20. The method of claim 19, wherein said serial communications interface is selected from the group consisting of RS-232, RS-422 and USB.

21. The system of claim 1, further comprising a command transmission collision detection circuit and a command retransmission circuit in said DALI master.

22. The system of claim 1, further comprising a command transmission collision detection circuit and a command retransmission circuit in said DALI sub-master.

23. The method of claim 10, further comprising the step s of detecting a transmission collision causing a corrupted command and retransmitting the corrupted command.

24. An apparatus for controlling luminaries from a plurality of different locations over a digital addressable lighting interface (DALI) control bus, said system comprising:
a DALI master having command transmission collision detection and command retransmssion; and
a DALI sub-master having command transmission collision detection and command retransmssion,
wherein said DALI master and said DALI sub-master are adapted for connection to a plurality of luminaries with a DALI control bus.

25. The system of claim 1, wherein said plurality of luminaries are selected from the group consisting of an incandescent light, a fluorescent light, a high pressure gas electric discharge light, a low pressure gas electric discharge light, light emitting diode light and electroluminescent light.

26. The method of claim 10, wherein said plurality of luminaries are selected from the group consisting of an incandescent light, a fluorescent light, a high pressure gas electric discharge light, a low pressure gas electric discharge light, light emitting diode light and electroluminescent light.

27. The apparatus of claim 24, wherein said plurality of luminaries are selected from the group consisting of an incandescent light, a fluorescent light, a high pressure gas electric discharge light, a low pressure gas electric discharge light, light emitting diode light and electroluminescent light.
